(19) United States
(12) Patent Application Publication
(10) Pub. No.: US 2025/0220621 A1
(43) Pub. Date: Jul. 3, 2025

(54) RANGING SERVICE EXPOSURE FRAMEWORK FOR WIRELESS MOBILE COMMUNICATIONS

(71) Applicant: Samsung Electronics Co., Ltd., Suwon-si, Gyeonggi-do (KR)

(72) Inventors: Tomasz Henryk MACH, Chertsey (GB); David Gutierrez ESTEVEZ, Chertsey (GB)

(21) Appl. No.: 18/852,194

(22) PCT Filed: Mar. 29, 2023
(86) PCT No.: PCT/KR2023/004159

§ 371 Date: Sep. 27, 2024

(30) Foreign Application Priority Data
Mar. 29, 2022 (GB) 2204476.2
May 6, 2022 (GB) 2206676.5

(51) Int. Cl. H04W 64/00; H04W 92/18

(52) U.S. Cl. CPC H04W 64/00; H04W 92/18

(57) ABSTRACT

A method of a reference user equipment (UE) for performing ranging with a target UE in a wireless communications system. The method comprises receiving from a requesting entity, a request for a ranging service with the target UE; performing ranging with the target UE; and transmitting to the requesting entity, a report of a result of the ranging, wherein the request is received from the requesting entity via one or more of a Gateway Mobile Location Centre (GMLC) and a Location Management Function (LMF) of the wireless communications system and the report is transmitted to the requesting entity via one or more of the GMLM and LMF.

### TECHNICAL FIELD

The present disclosure relates to a ranging service exposure framework for 5G mobile communications networks and methods of operating thereof.

### BACKGROUND ART

Wireless or mobile (cellular) communications networks in which a mobile terminal (UE, such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

The trend towards greater data throughput continues with the standardisation and deployment of Fifth Generation (5G) systems. As part of this, a new air interface is being developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. Among this functionality and use cases is ranging between UEs, where ranging includes determining a distance between a reference UE and a target UE and/or determining a direction of a target UE relative to a reference UE. However, control over such ranging functionality is currently limited to the core network, thus limiting its applicability and use cases.

### DISCLOSURE OF INVENTION

### Solution to Problem

It is an aim of certain embodiments of the present disclosure to address the issue of increasing the exposure of UE ranging capabilities to entities outside of the core network of a 3GPP system.

It is an aim of certain embodiments of the present disclosure to provide a framework that increases the available use cases for the ranging capabilities of a UE in a 3GPP system.

### BRIEF DESCRIPTION OF DRAWINGS

Embodiments of the present disclosure are further described hereinafter with reference to the accompanying drawings, in which:

FIG. 1 provides coverage scenarios of a user equipment (UE) and a serving next generation nodeB (gNB) in a 5G mobile communications system according to an embodiment of the disclosure.

FIG. 2 provides a 5G System architecture for ranging-based services according to an embodiment of the disclosure.

FIG. 3 provides a close contact proximity detection based on the proposed ranging service exposure framework according to an embodiment of the disclosure.

FIG. 4A provides an example call flow using the proposed ranging service exposure framework towards an application server according to an embodiment of the disclosure.

FIG. 4B provides an example call flow using the proposed ranging service exposure framework towards an application server according to an embodiment of the disclosure.

FIG. 5 provides a schematic diagram of a UE according to an embodiment of the disclosure; and

FIG. 6 provides a schematic diagram of a gNB according to an embodiment of the disclosure.

FIG. 7 is a flowchart illustrating a method of a reference user equipment (UE) for performing ranging with a target UE in a wireless communications system, according to an embodiment of the disclosure.

FIG. 8 is a flowchart illustrating a method of a requesting entity for requesting a ranging service between a reference user equipment (UE) and a target UE in a wireless communications system, according to an embodiment of the disclosure.

FIG. 9 is a block diagram of a UE, according to an embodiment of the disclosure. The UE may be one of the reference UE and the target UE.

FIG. 10 is a block diagram of a core network object in a wireless communication system, according to an embodiment of the disclosure.

### BEST MODE FOR CARRYING OUT THE INVENTION

According to a first aspect of the present disclosure there is provided a method of a reference user equipment (UE) for performing ranging with a target UE in a wireless communications system, the method comprises receiving from a requesting entity, a request for a ranging service with the target UE; performing ranging with the target UE; and transmitting to the requesting entity, a report of a result of the ranging, wherein the request is received from the requesting entity via one or more of a Gateway Mobile Location Centre (GMLC) and a Location Management Function (LMF) of the wireless communications system and the report is transmitted to the requesting entity via one or more of the GMLM and LMF.

In an embodiment of the present disclosure the requesting entity is one of a ranging application server or a ranging application function.

In an embodiment of the present disclosure the method further comprises registering one or more ranging capabilities of the reference UE and the target UE with a core network of the wireless communications system or the requesting entity.

In an embodiment of the present disclosure the request is based on one or more of the registered ranging capabilities of at least one of the reference UE and the target UE.

In an embodiment of the present disclosure the registering of one of more ranging capabilities with the core network comprises registering the one or more ranging capabilities with an Access and Mobility Management Function (AMF).

In an embodiment of the present disclosure the ranging capabilities include one or more of proximity-based services (ProSe) capabilities and a Location Privacy Indication (LPI).

In an embodiment of the present disclosure the ranging comprises one of distance measurement and direction measurement.

In an embodiment of the present disclosure the request includes one or more parameters for configuration of the ranging, and the method further comprises configuring the reference UE based on the one or more parameters.

In an embodiment of the present disclosure the configuring the reference UE is performed by a ProSe Application Server (ProSe AS) or Policy Control Function (PCF).

In an embodiment of the present disclosure the requesting entity is a ranging application server and the request is communicated to the GMLC directly or via a Network Exposure Function (NEF)

In an embodiment of the present disclosure the request includes an indication of one or more of for the ranging service: the target UE, the reference UE, a location Quality of Service, a number of events addressing distance and/or direction measurements between the reference and target UE, a threshold distance for an event, a threshold direction for an event, a time to trigger for an event, a direction orientation for an event, a threshold matching direction for an event, a measurement frequency for an event, a preferred accuracy for an event, and a privacy preservation criteria for an event.

In an embodiment of the present disclosure reporting the result of the ranging includes transmitting, to the requesting entity, an indication that a reporting threshold has been reached for at least one of: a range between the target UE and the reference UE, a range accuracy between the target UE and the reference UE, a ranging latency between the target UE and the reference UE, a direction between the target UE and the reference UE, a direction accuracy between the target UE and the reference UE, and a direction latency between the target UE and the reference UE.

In an embodiment of the present disclosure the request is communicated via the GMLC and the GMLC utilises a service operation of an Access and Mobility Management Function (AMF) to request the ranging service.

According to a second aspect of the present disclosure there is provided a reference user equipment (UE) for performing ranging with a target UE in a wireless communications system, the reference UE comprising: a transceiver; and at least one processor configured to: receive from a requesting entity, a request for a ranging service with the target UE; perform ranging with the target UE; and transmit to the requesting entity, a report of a result of the ranging, wherein the request is received from the requesting entity via one or more of a Gateway Mobile Location Centre (GMLC) and a Location Management Function (LMF) of the wireless communications system and the report is transmitted to the requesting entity via one or more of the GMLM and LMF.

According to a third aspect of the present disclosure there is provided a method of a requesting entity for requesting a ranging service between a reference user equipment (UE) and a target UE in a wireless communications system, the method comprising: transmitting, to the reference UE, a request for the ranging service; and receiving, from the reference UE, a report of a result of a ranging between the reference UE and the target UE, wherein the request is transmitted to the reference UE via one or more of a Gateway Mobile Location Centre (GMLC) and a Location Management Function (LMF) of the wireless communications system and the report is received from the reference UE via one or more of the GMLM and LMF.

According to a fourth aspect of the present disclosure there is provided a method for performing ranging between a reference UE and a target UE in a 3GPP mobile communications system, the method comprising: receiving, at the reference UE from a requesting entity, a request for a ranging service between the reference UE and the target UE; performing ranging between the reference UE and the target UE; and transmitting, from the reference UE to the requesting entity, a report of a result of the ranging, wherein the requesting entity communicates directly or indirectly with one or more of a Gateway Mobile Location Centre (GMLC) and a Location Management Function (LMF) of the 3GPP mobile communications system to transmit the request and receive the report.

In an embodiment of the present disclosure the requesting entity is one of a ranging application server or a ranging application function of a UE.

In an embodiment of the present disclosure the method further comprises registering with a core network of the 3GPP mobile communications system or the requesting entity one or more ranging capabilities of the reference UE and the target UE.

In an embodiment of the present disclosure the request is based on one or more of the registered ranging capabilities of at least one of the reference UE and the target UE.

In an embodiment of the present disclosure the registering of one of more ranging capabilities with the core network comprises registering the one or more ranging capabilities with an Access and Mobility Management Function (AMF).

In an embodiment of the present disclosure the ranging capabilities include one or more of proximity-based services (ProSe) capabilities and a Location Privacy Indication (LPI).

In an embodiment of the present disclosure the ranging comprises one of distance measurement and direction measurement.

In an embodiment of the present disclosure the request includes one or more parameters for configuration of the ranging, and the method further comprises configuring the reference UE and the target UE based on the one or more parameters and the ranging capabilities of the target UE and the reference UE.

In an embodiment of the present disclosure the configuring the reference UE and the target UE is performed by a ProSe Application Server (ProSe AS) or ProSe Policy Control Function (ProSe PCF).

In an embodiment of the present disclosure, the requesting entity is a ranging application server and the request is communicated to the GMLC directly or via a Network Exposure Function (NEF).

In an embodiment of the present disclosure, the request includes an indication of one or more of for the ranging service: the target UE, the reference UE, a location Quality of Service, a number of events addressing distance and/or direction measurements between the reference and target UE, a threshold distance for an event, a threshold direction for an event, a time to trigger for an event, a direction orientation for an event, a threshold matching direction for an event, a measurement frequency for an event, a preferred accuracy for an event, and a privacy preservation criteria for an event.

In an embodiment of the present disclosure reporting the result of the ranging includes transmitting from the reference UE to the requesting entity an indication that a reporting threshold has been reached for at least one of: a range between the target UE and the reference UE, a range accuracy between the target UE and the reference UE, a ranging latency between the target UE and the reference UE, a direction between the target UE and the reference UE, a direction accuracy between the target UE and the reference UE, and a direction latency between the target UE and the reference UE.

In an embodiment of the present disclosure, the request is communicated via the GMLC and the GMLC utilises a service operation of an Access and Mobility Management Function (AMF) to request the ranging service, and wherein the service operation includes one or more of the indications set out above for the request.

In an embodiment of the present disclosure, the request is communicated via an Access and Mobility Management Function (AMF) and the LMF, and the AMF utilises a service operation to request the ranging service from the LMF, and wherein the service operation includes one or more of the indications set out above for the request.

In an embodiment of the present disclosure, the request is communicated via a selected LMF, and the selected LMF is determined based on ranging capabilities supported by the selected LMF.

According to a fifth aspect of the present disclosure there is provided a 3GPP mobile communications system configured to implement any of the above-described methods.

According to a sixth aspect of the present disclosure there is provided a method of a user equipment for performing ranging between with a target UE in a 3GPP mobile communications system, the method comprising: receiving from a requesting entity, a request for a ranging service with the target UE; performing ranging with the target UE; and transmitting to the requesting entity, a report of a result of the ranging, wherein the request is received from and the report transmitted to the requesting entity via one or more of a Gateway Mobile Location Centre (GMLC) and a Location Management Function (LMF) of the 3GPP mobile communications system.

In an embodiment of the present disclosure the requesting entity is one of a ranging application server or a ranging application function of a UE.

According to a seventh aspect of the present disclosure there is provided user equipment (UE) for use in a 3GPP mobile communications network, wherein the UE is configured to implement the method of the third aspect.

Another aspect of the present disclosure provides a computer program comprising instructions arranged, when executed, to implement a method and/or apparatus in accordance with any one of the above-described aspects and relates embodiments. A further aspect provides machine-readable storage storing such a program.

### MODE FOR THE INVENTION

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Advantages and features of the disclosure, and methods for attaining them will be understood more clearly with reference to the following embodiments of the disclosure, which will be described in detail later along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each blocks and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-usable or computer-readable memories oriented for computers or other programmable data processing equipment, so it is possible to manufacture a product that contains instruction means for performing functions described in the block(s) of the flowchart. The computer program instructions may also be loaded on computers or programmable data processing equipment, so it is possible for the instructions to generate a process executed by the computer or the other programmable data processing equipment to provide operations for performing functions described in the block(s) of the flowchart.

Furthermore, each block may represent a part of a module, segment, or code including one or more executable instructions to perform particular logic function(s). It is noted that the functions described in the blocks may occur out of order in some alternative embodiments of the disclosure. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a less number of components and modules, or further divided into a more number of components and modules. Moreover, the components and modules may be implemented to execute one or more central processing units (CPUs) in a device or security multimedia card. In embodiments of the disclosure, the module may include one or more processors.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, or the like.

In the disclosure, a controller may also be referred to as a processor.

Throughout the specification, a layer (or a layer apparatus) may also be referred to as an entity.

Descriptions of some well-known technologies that possibly obscure the disclosure will be omitted, if necessary. Embodiments of the disclosure will now be described with reference to accompanying drawings.

Herein, terms to identify access nodes, terms to refer to network entities, terms to refer to messages, terms to refer to interfaces among network entities, terms to refer to various types of identification information, etc., are examples for convenience of explanation. Accordingly, the disclosure is not limited to the terms as herein used, and may use different terms to refer to the items having the same meaning in a technological sense.

Some of the terms and names defined by the 3^{rd} generation partnership project (3GPP) long term evolution (LTE) will be used hereinafter. The disclosure is not, however, limited to the terms and definitions, and may equally apply to any systems that conform to other standards. In particular, the disclosure may be applied to the 3GPP new radio (NR) (which is the 5^{th} generation (5G) mobile communication standard). In the disclosure, eNode B (eNB) may be interchangeably used with gNode B (gNB). For example, a base station referred to as an eNB may also indicate a gNB. Furthermore, the term ‘terminal’ or ‘user equipment (UE)’ may refer not only to a cell phone, an NB-IoT device, and a sensor but also to other wireless communication devices.

In the following description, a base station is an entity for performing resource allocation for a terminal, and may be at least one of a gNB, an eNB, a Node B, a base station (BS), a radio access unit, a base station controller, or a node on a network. The terminal may include a UE, an MS, a cellular phone, a smart phone, a computer, or a multimedia system capable of performing a communication function. The disclosure is not limited thereto.

The term ‘service’ may be interchangeably used with a service performed by a certain communication equipment (or network function (NF)) at the request of another communication equipment (or another NF) (i.e., an NF service), a service provided by a mobile network operator (i.e., a voice service, a text service, a data service, etc.), or a service provided by an over-the-top (OTT) operator (i.e., a messenger service, a game service, etc.).

The mobile communication system may provide UE attachment, registration, and session connection (or public data network (PDN) connection, protocol data unit (PDU) session) for providing a service. For this, a protocol may be defined between the UE and an NF in the mobile communication system, in which case the UE and the NF may exchange various parameters defined in a control plane signaling protocol.

In embodiments of the disclosure, when the parameter (e.g., data network name (DNN), single NSSAI (S-NSSAI), or the like) transmitted by the UE to the NF is not valid or may not be provided in the mobile communication system (e.g., 5th generation system (5GS), evolved packet system (EPS), or the like), the parameter transmitted by the UE may be replaced with an available parameter instead of rejecting the request of the UE or releasing the session, thereby preventing service errors or customer service quality degradation.

Embodiments in accordance with the present disclosure will now be described in the context of a 5G wireless communication network. However, it will be understood that the present disclosure is not limited to only 5G systems but may be applied to other wireless communication systems including a core network and in which ranging between mobile devices is available. Consequently, references to particular 3GPP constructs in certain embodiments should not be understood as limiting the ability of embodiments of the present disclosure to be applied to other wireless communication networks.

Ranging refers to the determination of the distance between two user equipment (UEs) instances and/or the direction of one UE, i.e. target UE, relative to the other one, i.e. reference UE, via direct device connection.

Ranging-based services can be used in a variety of verticals including consumer, smart home, smart city, smart transportation, smart retail, and industry 4.0. Specific use cases for ranging have been specified by 3GPP in 3GPP TR 22.855 v17.0.1 24 Jun. 2021—Study on Ranging-based Services. Functional requirements of ranging are set out in 3GPP TS 22.261 v18.5.0 24 Dec. 2021—Service requirements for the 5G system.

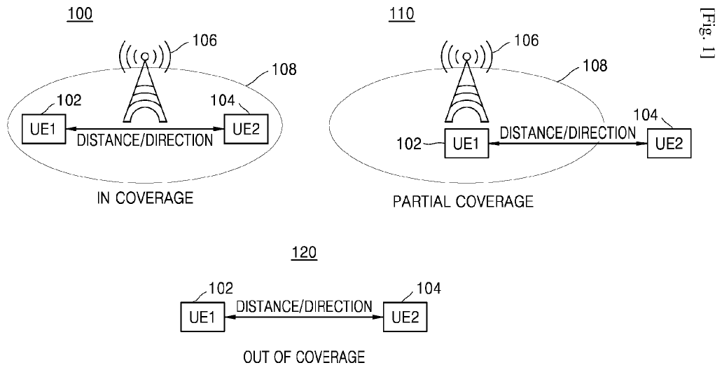

Ranging can be performed in licensed, unlicensed and ITS spectrum, where the ranging is performed using sidelink communications (PC5 interface) between the UEs, when the UEs are in-coverage, in partial coverage, and out-of-coverage of 5G network. FIG. 1 illustrates the various coverage examples in which ranging may be performed. In 100, both UE1 102 and UE2 104 are within the coverage area 108 of a gNB 106 of the 5G system. In 110, the UE1 102 is within the coverage area 108 of a gNB 106 of the 5G system but UE2 102 is outside of the coverage area 108 of the gNB 106. In 120, both UE1 102 and UE2 104 are outside of a coverage area 108 of the gNB 106 of the 5G system. Example use cases for ranging include commercial, vehicle-to-everything (V2X) and public safety.

In 3GPP TS 22.261 v18.5.0 24 Dec. 2021—Service requirements for the 5G system a number of high level 5G system functional ranging requirements are identified, including

The 5G system shall be able to enable or disable ranging.

The 5G system shall support mutual ranging, i.e. two UEs shall be able to initiate ranging to each other.

The 5G system shall be able to start ranging and stop ranging according to the application layer's demand.

The 5G system shall be able to provide mechanisms for a Mobile Network Operator (MNO), or authorized 3rd party, to provision and manage ranging operation and configurations.

The 5G system shall allow ranging between two UEs triggered by and exposed to a third UE.

The 5G system shall allow ranging service between two UEs triggered by and exposed to the application server.

The 5G system shall be able to support ranging enabled UEs to determine the ranging capabilities (e.g. capabilities to perform distance and/or angle measurement) of other ranging enabled UEs

The 5G system shall be able to support one UE initiating ranging to the other UE.

Furthermore, in 3GPP TR 23.700-86 0.1.0 4 Mar. 2022 —Study on Architecture Enhancement to support Ranging based services and sidelink positioning, among others, two further key requirements were specified:

Key Issue #6: Ranging and sidelink positioning service exposure to a UE—The Ranging/Sidelink positioning service between two Ranging/Sidelink positioning capable UEs may be exposed to a third UE to obtain the Ranging/Sidelink positioning information between the two UEs.

Key Issue #7: Ranging/Sidelink Positioning service exposure to Application server and for network assisted sidelink positioning—Application Server may initiate the Ranging/Sidelink Positioning service request for acquiring Ranging information between two UEs.

Consequently, the present disclosure provides architecture enhancements and/or frameworks for enabling ranging-based services and sidelink (PC5 interface) positioning for commercial, V2X and public safety use cases in various coverage scenarios, and in particular;

Ranging device discovery and service operation procedures between two UEs, between one UE and multiple UEs or via the assistance of another UE;

Ranging and sidelink positioning service exposure to a UE or an Application Server who has requested the service

Furthermore information on these two requirements can be found in SP-211647—New SID on Study on Architecture Enhancement to support Ranging based services and sidelink positioning—(TSG SA Meeting #SP-94E; 14-20-12-2021), where Work Tasks 1.3 and 1.5 relate to ranging device discovery and service operation procedures between two UEs, between one UE and multiple UEs or via the assistance of another UE; and ranging and sidelink positioning service exposure to a UE or an Application Server who has requested the service, respectively.

In particular, the present disclosure introduces a ranging service exposure framework for 5G systems that can be used in different ranging use cases (e.g. commercial, V2X and public safety) to determine the distance and/or direction measurement directly between two UEs using device to device PC5 interface in various mobile network coverage scenarios, where the ranging services are able to be exposed and controlled by an increased range of entities.

In addition, the disclosed framework leverages ranging device discovery and service operation procedures between two UEs based on 3GPP Proximity-based Services (ProSe) and the location reporting architecture based on 3GPP Location Services (LCS). Novel aspects of the disclosed framework include the capability for ranging service exposure to an Application Server requesting the service and the core network entities involved in enabling this exposure, and a new procedure including such capability within the overall framework. In addition, the present disclosure defines new events for measuring ranging distance and direction and also describes different ranging configuration aspects such as UE ranging capability signalling and messaging and also ranging events configuration and reporting.

The present disclosure also proposes an example proximity detection procedure for contact tracing systems as a new use case for the proposed ranging framework not currently considered by 3GPP. To this end, the application of 5G sidelink ranging technology may be beneficial for future contact tracing apps, particularly if it could be privacy preserving and its achievable ranging accuracy is better than the ranging accuracy achievable by received Bluetooth RSSI signal level measurements currently used in most contact tracing apps e.g. such as NHS Covid-19 app used in UK. However, the ranging techniques proposed in this disclosure are not limited to such an example.

### Ranging Architecture

The framework provided by the present disclose to provide the above-described functionality builds upon the Proximity-based Services (ProSe) sub-system and the Location Services (LCS) sub-system with 5G systems. In particular, for ranging-based services, the 5G System architecture defined by 3GPP in section 4.2.1 of 3GPP TS 23.304 v17.2.1 25 Mar. 22 —Proximity based Services (ProSe) in the 5G System (5GS) may be built upon with following changes.
Ranging Application Server is used instead of or in addition to ProSe Application Server in Data Network
Ranging Application is used instead of or in addition to ProSe Application in target UE and reference UE
Reference UE is used for the UE which determines a reference plane and reference direction in the Ranging based service and Sidelink positioning.

Target UE is used for a UE whose distance, direction and/or position is measured in comparison to the reference plane, reference direction and/or location of a Reference UE in Ranging based services and Sidelink positioning.

In addition it is expected but not mandated (i.e. alternatives may be used) that the following existing ProSe features defined in 3GPP TS 23.304 v17.2.1 25 Mar. 22—Proximity based Services (ProSe) in the 5G System (5GS) will be reused for ranging and thus they will not be discussed in detail here.
5G ProSe Direct Discovery to support identification that reference and target UEs are in proximity
5G ProSe Direct Communication to support establishment of communications paths between reference and target UEs

With regards to LCS, it is assumed that the service exposure framework proposed in this disclosure leverages the Network Functions (NFs) within LCS, namely the Gateway Mobile Location Centre (GMLC) and the Location Management Function (LMF). In particular, any interaction with the external ranging application server defined above (via the Network Exposure Function, NEF) should be performed by the GMLC, which, in cooperation with LMF, arranges sidelink-based positioning measurements to be performed by the UEs and delivered to the network.

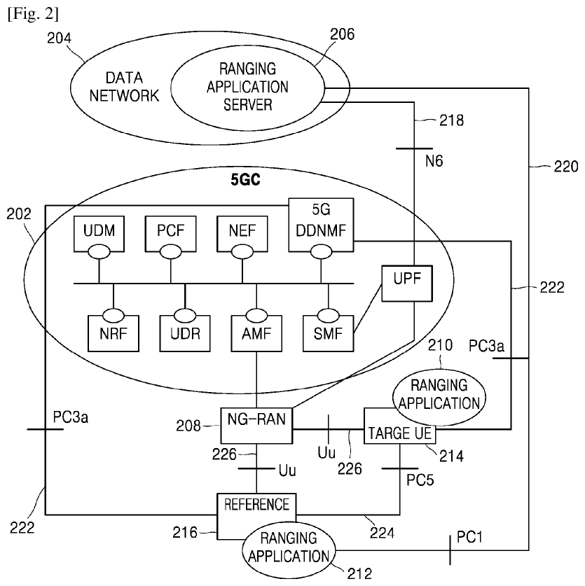

FIG. 2 provides a system architecture diagram for ranging-based services in accordance with the present disclosure. The architecture includes the 5G core network 202 which may include but is not only limited to including a Unified Data Management (UDM), Policy Control Function (PCF), Network Exposure Function (NEF), Inter-5G Direct Discovery Name Management Function (5G DDNMF), Network Repository Function (NRF), Unified Data Repository (UDR), Access and Mobility Management Function (AMF), Session Management Function (SMF), and User Plane Function (UPF). The architecture further includes Next Generation Radio Access Network (NG RAN) 208 which provides radio access to the reference UE 216 and target UE 214 when they are within the coverage of the NG RAN, via the Uu (i.e. RAN) interface 226. The UEs may also communicate with the 5G DDNMF in the core network via the PC3a interface 222. A data network 204 is connected to the UPF via an N6 interface 218, and a ranging application server 206 and ranging applications 210 and 212 operating across the UEs and data network 204 and may communicate via a non-standardised PC1 interface 220, which may take any suitable form. The ranging application server 206 may also communicate with the UPF of the core network 202 via the N6 interface 218. The reference UE 216 and the target UE 214 can communicate directly using the PC5 (sidelink) interface 224 and it is via this interface that ranging is performed between the reference and target UEs. Further information on the entities and interfaces/reference points can be found in 3GPP TS 23.304 v17.2.1 25 Mar. 22 —Proximity based Services (ProSe) in the 5G System (5GS).

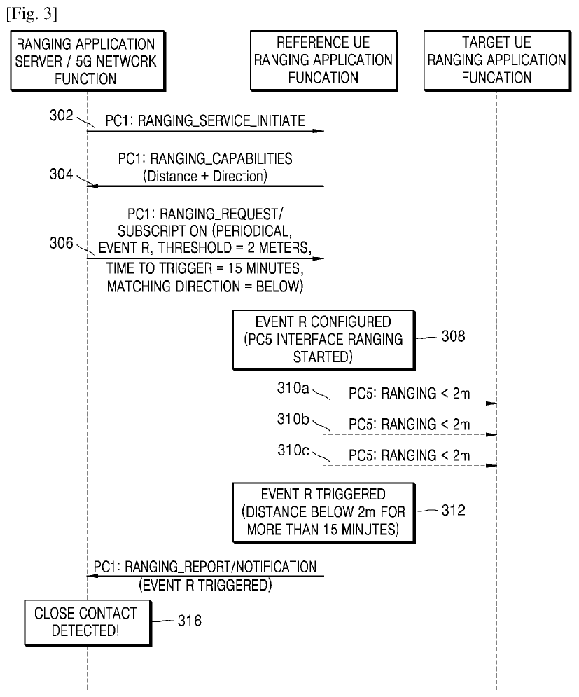

FIG. 3 provides an example approach for performing ranging between a reference UE and a target UE using the proposed Framework where the ranging procedure is being used in a contract tracing scenario in which the ranging may be exposed to a ranging application server or some other 5G network function or external entity. In particular, FIG. 3 depicts a close contact proximity detection scenario, where Covid19 contact tracing apps using Bluetooth RSSI measurements for estimating distance are conventionally used. In this particular example, the ranging services are used to detect a close contact situation when a measured distance between and an observer UE (i.e. reference UE) and a target UE is below 2 meters for more than 15 minutes. Such an application could be used for automated detection of COVID-19 exposure as a complementary solution to manual tracing (interviews with people diagnosed with COVID19 to track down their recent contacts etc.) It should be noted however that the proposed UE ranging service exposure framework could support other ranging based use cases and the parameters and message naming specified in relation to FIG. 3 are merely exemplary and may take any suitable form.

At step 302, a RANGING_SERVICE_INITIATE message communicated via the PC1 interface is used to initiate the ranging procedure in the reference UE ranging application function, where the initiation may be performed by various different entities, such as a Ranging Application Server or 5G Network Function for example.

At step 304, in response to the RANGING_SERVICE_INITIATE command, the Reference UE Ranging Application Function (AF) replies with a RANGING_CAPABILITIES message across the PC1 interface detailing the specification of its ranging measurement capabilities e.g. distance only, direction only or both. and measurement performance information e.g. maximum and or minimum measured range, direction measurements limitations, measurement latency, speed and frequency, accuracy, error, confidence level, privacy preservation.

At step 306, at least partially based on the content of the RANGING_CAPABILITIES message, the initiating entity transmits a RANGING_REQUEST_SUBSCRIPTION over the PC1 interface to the Reference UE Ranging AF, where the message provides ranging distance and/or direction measurements configuration based on preconfigured events (see below for more details). This message also acts to initiate the distance and/or direction measurements to the Target UE Ranging Application Function on the PC5 interface/reference point in the Reference UE Ranging Application Function (AF). This step of the procedure may be initiated by the Ranging Application Server or 5G Network Function, but is not only limited to these entities. With respect to the particular configuration parameters of step 306, an example periodical event R is configured based on a distance threshold of 2 m, a time to trigger of 15 minutes, and matching direction, such the event R will be triggered if the reference UE and the target UE are within 2 m of each other for 15 mins.

At step 308, the Reference UE Ranging AF performs the necessary configuration for detecting the event R detailed in the RANGING_REQUEST/SUBSCRIPTION and starts the ranging.

Steps 310a-c represent the periodic ranging performed by the reference UE and target UE, which may include detecting distance or direction measurements to Target UE Ranging Application Function on PC5 interface/reference point in the Reference UE Ranging Application Function (AF). The ranging steps 310a-c assume a RAN protocol stack capability to perform physical ranging or direction measurements. In this example, if the distance between the reference UE and the target UE is less than 2 m for at least 15 minutes, the event R is trigged within the Reference UE Ranging AF at step 312.

The ranging represented by steps 310a-c may also be performed using any suitable radio technology (i.e. other than 5G NR), such that different technologies can be used for to perform actual ranging or direction measurements (i.e. the measurement control/exposure part using 5G technologies is separated from the physical measurement implementation). For example ultra-wideband may be used for the ranging and direction measurements. Alternatively, existing or future techniques based upon RSSI measurements in Bluetooth or WiFi may also be used in conjunction with the control and exposure aspects of the 5G system. Further alternatives for the raging or direction measurements include ITS-G5, 802.11p, radar od LIDAR technologies.

At step 314, upon the event R being triggered, the Reference UE Ranging AF transmits a RANGING_REPORT/NOTIFICATION to the initiating entity.

At step 316, the initiating entity determines that a close contact has been detected based on the event R. However, depending on the intended use of the ranging, any suitable conclusion/determination may be based on the event R.

Although the procedure of FIG. 3 has been described with respect to a particular event configuration, initiating entities and communication interfaces, it is not limited to these and any suitable combination of interfaces and configurations may be used. For example, the initiating entity may be a UE and/or events may be preconfigured at the UE to account for scenarios where a UE may be out of coverage, thus allowing the various coverage scenarios to be catered to. Furthermore, the reference UE may be in coverage whereas the target UE may be out of coverage. A more detailed description of event configurations is set out below.

As part of the proposed service exposure framework for ranging, one or more new events are defined, where these events may be used for exposure towards the application server (e.g. ranging application server) or for service exposure between UEs. The various parameters of the defined events may be appropriately configured to enable particularly ranging scenarios to be detected or monitored. In some examples this may reduce the overheads associated with reporting ranging results since reporting may be configured to occur only when ranging results fulfilling certain parameters occur. For example, with reference to FIG. 3, reporting occurs when the target UE is within 2 m for at least 15 minutes and thus ranging results when either the distance threshold or duration threshold are not satisfied may not be reported. Alternatively the status of the ranging may be reported are regular intervals or in response to a particular request.

To support the ranging service exposure framework in 5G systems for distance measurements the following non-exhaustive list of new events may be defined:
Event R—Range between target and reference UE reached a reporting threshold
Event RA—Range accuracy between target and reference UE reached a reporting threshold
Event RL—Ranging latency between target and reference UE reached a reporting threshold

To support the ranging service exposure framework in 5G system for direction measurements the following non-exhaustive list of new events may be defined:
Event D—Direction between target and reference UE reached a reporting threshold
Event DA—Direction accuracy between target and reference UE reached a reporting threshold
Event DL—Direction latency between target and reference UEs reached a reporting threshold

One or more of the above-listed events may be configured separately or simultaneously such that a UE monitors for one or more events and notifies/reports of the occurrence of the one or more of the events. Multiple events may also be configured by a single request from a requesting entity. Likewise, one or more events may be notified/reported via a single reporting message. The events able to be monitored by the UE may be determined by the UE's capabilities and thus it may not be possible to monitor for all events at a UE. Information on the events that a UE can monitor may be included in the registered capabilities of the UE and thus used in the configuration of the event monitoring. The configured events may also be used to determine the ranging/direction detection procedures performed by the UE so that unnecessary procedure are not performed.

In addition, every event may include additional configuration parameters which could be mandatory or optional, as shown in the following non-exhaustive list below.
Reporting threshold—defines exact value of the relevant parameter (e.g. range, range accuracy, ranging latency, direction, direction accuracy, direction latency)
Time To Trigger—amount of time required for the event condition to be fulfilled before triggering (reporting) the event
Direction orientation (only for direction measurements events)—Horizontal or Vertical
Matching direction (optional)—A matching direction may be provided such as below, above, or crossed. If no matching direction is provided, the default direction is crossed
Minimum ranging or direction measurement frequency—“Low”, “Medium”, “High” or “Highest” or actual value in ms could be defined
Preferred level of accuracy (optional for event R and D only)—“Low”, “Medium”, “High” or “Highest”
Privacy preservation (optional)—“Enabled” or “Disabled”. Could be beneficial for ranging scenarios where the target UE user identification should be hidden (e.g. for the Covid-19 contact tracing use case)

FIG. 4A provides a detailed example of a call flow using the proposed service exposure framework towards an application server, where the interfacing between the entities of the core network and between the core network and the other entities of the network are detailed. It will be appreciated that one or more of the steps of FIG. 4A may be omitted or performed at different times such that the steps are not necessary performing in response to one another. Furthermore, one or more additional steps may be introduced without affecting the functionality of the proposed service exposure framework. For example, step 402 may be periodically performed or performed when a UE registers with the 5G system, and thus step 404 may be performed at any time after 402 has been performed. As for FIG. 3, although the messages of FIG. 4A have been allocated particular labels, these are merely example labels and any suitable label may be used, with the information conveyed by the message being of relevance.

At step 402, the ProSe capabilities of the UEs are registered with the AMF beforehand i.e. before any request for ranging. This may include the support for location reporting in addition to other ProSe capabilities. Also the Location Privacy Indication (LPI) defined in 3GPP TS 23.273 v17.4.0 23 Mar. 2022-5G System (5GS) Location Services (LCS) for ProSe based localization can be given by the UEs at this stage, again to the AMF.

At step 404, a ranging/sidelink positioning service request is made via the NEF, where this new set of services offered by NEF and GMLC allow the ranging application server to provide a ranging or sidelink positioning request to the 5G system. This service operation may include a number of new events and the events may include a number of mandatory or optional configuration parameters, as defined above with reference to FIG. 3. Consequently, with reference to step 410, the request is directly or indirectly communicated (e.g. to the reference UE) via one or more of the GMLC or the LMF of the 5G mobile communications system to enable the ranging services to be initiated, controlled or configured by an increased range of external entities, such as the Ranging Application Server. Although step 404 is shown to originate from the Ranging Application Server, the process is not so limited and may originate from other entities such as a UE involved in the ranging or a third party UE for example.

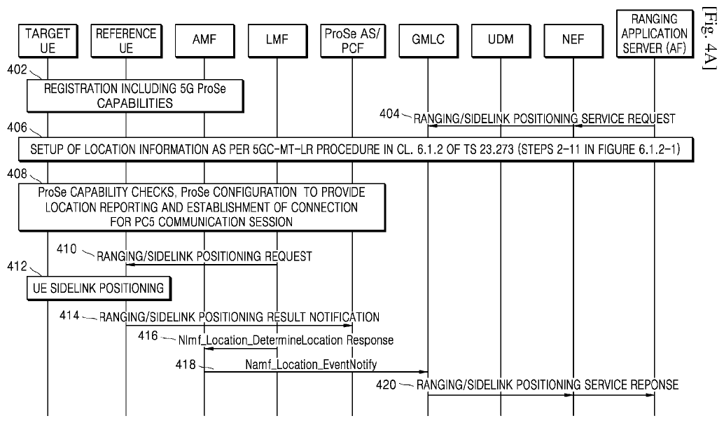

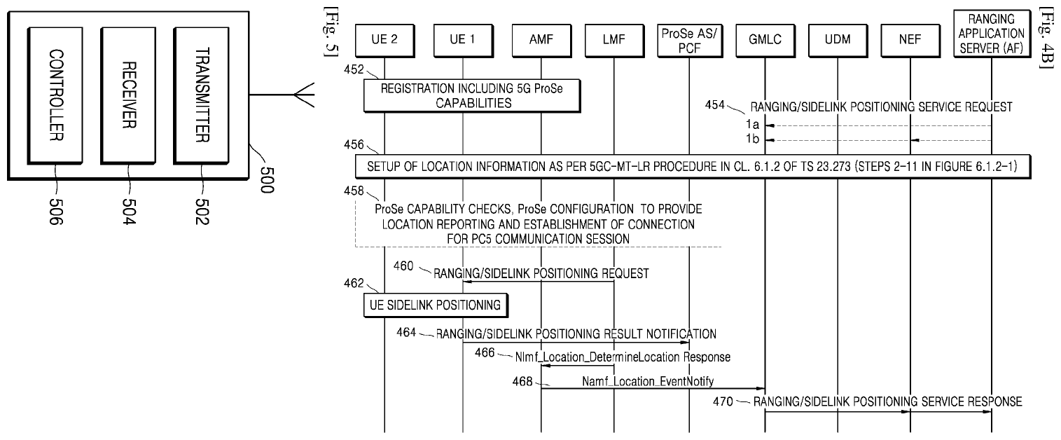

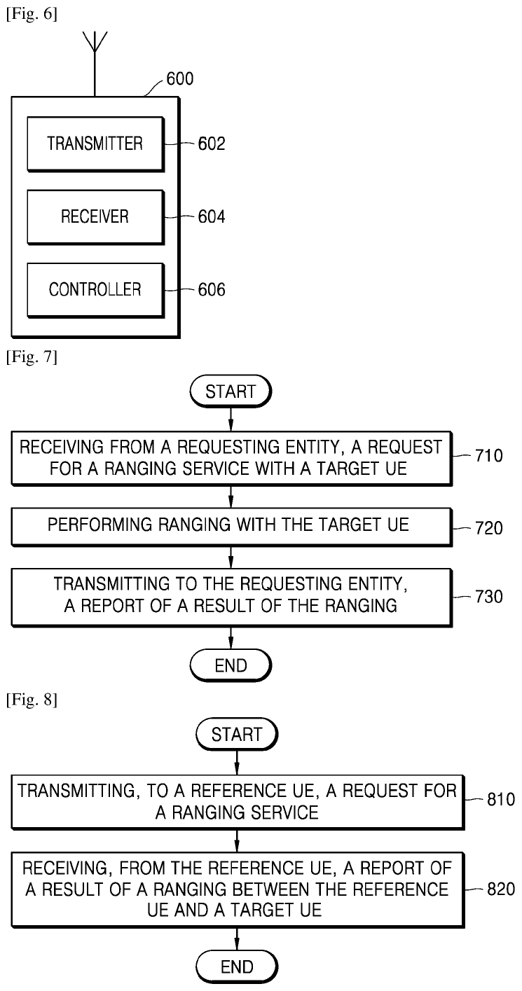

At step 406, location information setup is performed as per 5GC-MT-LR procedure in 3GPP TS 23.273 v17.4.0 23 Mar. 2022-5G System (5GS) Location Services (LCS), corresponding to steps 2-11 in FIG. 6.1.2-1 contained in clause 6.1.2, potentially including new optional inputs as part of the existing service operations accounting for the ranging related events. In some examples, if the target UE is out of coverage such a setup at the target UE may be performed via another network or via the reference UE.

At step 408, the LMF checks the ProSe capabilities registered for the UEs in Step 402 with the AMF, the ProSe AS or PCF configures the UE to provide location reporting as needed, and a connection is established for a PC5 communication session.

At step 410, the LMF sends a ranging/sidelink positioning request to the reference UE.

At step 412, the reference UE performs sidelink-based positioning on the target UE using the PC5 interface.

At step 414, the reference UE sends the ranging/sidelink positioning results and/or notification to the LMF.

At step 416, the LMF forwards the ranging/sidelink positioning results/notification to the AMF.

At step 418, the AMF forwards the ranging/sidelink positioning results/notification to the GMLC.

At step 420, the GMLC exposes the ranging/sidelink positioning results/notification to the ranging application server via NEF with the response operation in the service employed in step 404.

Using the proposed framework described with reference to FIG. 4A, the entities to which ranging may be exposed to and controlled by can be increased, since ranging may be exposed to additional applications across the UE and data network. However, the core network and the entities thereof (e.g. NEF, GMLC, LMF and AMF) still take part in the configuration of the ranging. Consequently, the core network does retain an element of control of the ranging procedure. In particular, a ranging request may be transmitted to the GMLC/NEF from an entity external to the core network, such as a particular application server or a UE, and thus the GMLC or NEF may be an arbiter of whether the ranging request is granted.

FIG. 4B provides another detailed example of a call flow using the proposed service exposure framework towards an application server, where the interfacing between the entities of the core network and between the core network and the other entities of the network are detailed. It will be appreciated that one or more of the steps of FIG. 4B may be omitted or performed at different times such that the steps are not necessary performing in response to one another. Furthermore, one or more additional steps may be introduced without affecting the functionality of the proposed service exposure framework. For example, step 452 may be periodically performed or performed when a UE registers with the 5G system, and thus step 454 may be performed at any time after 452 has been performed. As for FIG. 3, although the messages of FIG. 4B have been allocated particular labels, these are merely example labels and any suitable label may be used, with the information conveyed by the message being of relevance. Although the examples of FIGS. 4A and 4B are described separately, their steps may be combined and/or their details are equally applicable to each example unless stated otherwise.

At step 452, the ProSe capabilities of the UEs are registered with the AMF beforehand. This may include the support for location reporting in addition to other ProSe capabilities. Also the Location Privacy Indication (LPI) defined in 3GPP TR 38.845 v17.0.0 1 Oct. 2021 and 3GPP TS 23.273 v17.4.0 23 Mar. 2022 for ProSe and location services respectively, can be given by the UEs at this stage, again to the AMF.

At step 454, a ranging/sidelink positioning service request (via NEF) is made. In particular, the ranging application server may contact GMLC directly (1a) or via NEF (1b) to provide a ranging or sidelink positioning operation request to the 5GS.

The service operations involved in the ranging/sidelink positioning request may reuse and extend the existing NEF/GMLC services (e.g. Nnef_EventExposure_Subscribe, Ngmlc_Location_ProvideLocation) and/or new service operations may be defined if needed. The service operations may include the target and reference UEs, the required location QoS, and a number of events addressing distance and/or direction measurements between the reference and target UEs. The service operations may also indicate threshold(s) for distance (i.e. range) and/or direction events. In addition, the service operations may include other event configuration parameter(s) that may be mandatory or optional (e.g. time to trigger, direction orientation, threshold matching direction, measurement frequency, preferred accuracy, privacy preservation, measurement latency). An indication of any of the configuration parameters described with reference to the service request(s) of FIGS. 3 and 4 may also be included in the service request(s) of FIG. 4B.

At step 456, the setup of location information as per 5GC-MT-LR procedure in 3GPP TS 23.273 v17.4.0 23 Mar. 2022 is performed, corresponding to steps 2-11 in FIG. 6.1.2-1 contained in clause 6.1.2, potentially including new optional inputs as part of the existing service operations accounting for the ranging related events.

The following enhancements of the 5GC-MT-LR procedure in 3GPP TS 23.273 v17.4.0 23 Mar. 2022 (6.1.2) may be used to support ranging/sidelink positioning:

Step 5 of the 5GC-MT-LR procedure in 3GPP TS 23.273 v17.4.0 23 Mar. 2022: an AMF service is consumed by GMLC to request ranging/sidelink positioning. The service operation can be Namf_Location_ProvidePositioningInfo with the same enhancements (i.e. new event configuration parameters) described above for Ngmlc_Location_ProvideLocation or a new service operation could be defined if needed.

Step 10 of the 5GC-MT-LR procedure in 3GPP TS 23.273 v17.4.0 23 Mar. 2022: an LMF that supports ranging/sidelink positioning should preferably be selected. In other words, a selected LMF is determined based on the ranging/sidelink positioning (i.e. ranging service) capabilities of the available LMFs.

Step 11 of the 5GC-MT-LR procedure in 3GPP TS 23.273 v17.4.0 23 Mar. 2022: either the Nlmf_Location service operations should be extended to support ranging/sidelink positioning with the enhancements (i.e. new event configuration parameters) described for Ngmlc_Location_ProvideLocation service operation or a new service operation should be defined for that purpose.

Referring back to FIG. 4B, at step 458, if not done yet, the LMF checks the ProSe capabilities registered for the UEs in step 452 with the AMF. The ProSe AS or PCF may authorize and/or configure the UEs to provide location reporting as needed, and a connection is established for PC5 communication session. The reference UE (acting similar to a ProSe UE-to-Network Relay as specified in TS 23.304 v17.2.1 25 Mar. 2022) may be configured or provisioned with special Relay Service Codes (RSCs) authorized for location reporting. This is provided by the PCF, already provisioned in the ME or configured in the UICC. Step 458 is optional.

At step 460, The LMF sends a ranging/sidelink positioning request to UE 1 (i.e. the reference UE). UE 1 is assumed to be in coverage for this solution; however UE 1 may also be out of coverage and the request provided to UE 1 via an alternative network. UE 1 may also act as reference UE or target UE.

At step 462, UE 1 initiates the ranging/sidelink-based positioning operation on UE 2.

At step 464, UE 1 sends the ranging/sidelink positioning measurements and/or results to the LMF.

At step 466, the LMF forwards the ranging/sidelink positioning results to the AMF.

At step 468, the AMF forwards the ranging/sidelink positioning results to the GMLC.

At step 470, the GMLC exposes the ranging/sidelink positioning results to the ranging application server via NEF with the response operation of the service employed in step 454.

The results of and response to the ranging services described with respect to FIG. 4B (e.g. any of steps 464-470) may also include any of the indications/event information set out above for the ranging service results/responses described with respect to FIGS. 3 and 4. Indications of results corresponding to any of the configuration parameters set out above for the service request(s) may also be included in the results of and response to the ranging services.

FIG. 5 provides a schematic diagram of the structure of a gNB 500 which is arranged to operate in accordance with any of the examples described above, and in particular the operations performed by the NG-RAN of FIG. 2. The gNB 500 includes a transmitter 502 arranged to transmit signals to a UE; a receiver 504 arranged to receive signals from a UE; and a controller (or processor) 506 arranged to control the transmitter and receiver and to perform processing such as in accordance with the above described methods, and also to communicate with the core network.

FIG. 6 provides a schematic diagram of the structure of a UE 600 which is arranged to operate in accordance with any of the examples of the present disclosure described above, for example the steps performed by either the reference or target UEs described with reference to FIGS. 2, 3, and 4. The UE 600 includes a transmitter 602 arranged to transmit signals to one or more gNBs; a receiver 604 arranged to receive signals from one or more gNBs and other UEs; and a controller 606 arranged to control the transmitter and receiver and to perform processing in accordance with the above described methods.

Although in FIGS. 5 and 6 the transmitter, receiver, and controller have been illustrated as separate elements, any single element or plurality of elements which provide equivalent functionality may be used to implement the examples of the present disclosure described above.

The structure of FIG. 5 may also more generally represent a block diagram of exemplary network entities that may be used in examples of the present disclosure, such as the techniques/architectures disclosed in relation to FIGS. 1 to 4a. For example, the NEF, UDM, GMLC, ProSe AS/PCF, LMF, and AMF and/or other NFs may be provided in the form of the network entity illustrated in FIG. 5. In particular, the receiver 504 may be configured for receiving one or more messages from one or more other network entities, for example as described above. The transmitter 502 may be configured for transmitting one or more messages to one or more other network entities, for example as described above. The controller 506 is configured for performing one or more operations, for example according to the operations as described above.

FIG. 7 is a flowchart illustrating a method of a reference user equipment (UE) for performing ranging with a target UE in a wireless communications system, according to an embodiment of the disclosure.

In operation 710, the reference UE receives from a requesting entity, a request for a ranging service with the target UE. The requesting entity may be one of a ranging application server or a ranging application function. The request may be directly or indirectly communicated to the reference UE via one or more of the GMLC or the LMF of the 5G mobile communications system to enable the ranging services to be initiated, controlled or configured by an increased range of external entities, such as the Ranging Application Server. The requesting entity may be a ranging application server and the request may be communicated to the GMLC directly or via a Network Exposure Function (NEF). One or more ranging capabilities of the reference UE and the target UE may be registered with the core network of the wireless communications system or the requesting entity. The ProSe capabilities of the UEs are registered with the AMF beforehand i.e. before receiving any request for ranging, Also the Location Privacy Indication (LPI) defined in 3GPP TS 23.273 v17.4.0 23 Mar. 2022-5G System (5GS) Location Services (LCS) for ProSe based localization can be given by the UEs at this stage, again to the AMF. The ranging/sidelink positioning service request may be received via the NEF. The request includes one or more parameters for configuration of the ranging. As defined step 408 with reference to FIG. 4A, location information setup is performed as per 5GC-MT-LR procedure in 3GPP TS 23.273 v17.4.0 23 Mar. 2022-5G System (5GS) Location Services (LCS), corresponding to steps 2-11 in FIG. 6.1.2-1 contained in clause 6.1.2, potentially including new optional inputs as part of the existing service operations accounting for the ranging related events. The LMF checks the ProSe capabilities registered for the UEs with the AMF, the ProSe AS or PCF configures the UE to provide location reporting as needed, and a connection is established for a PC5 communication session. The LMF sends a ranging/sidelink positioning request to the reference UE.

In operation 720, the reference UE performs ranging with the target UE. The reference UE performs sidelink-based positioning on the target UE using the PC5 interface. The ranging comprises one of distance measurement and direction measurement.

In operation 730, the reference UE transmits to the requesting entity, a report of a result of the ranging. The report is transmitted to the requesting entity via one or more of the GMLM and LMF.

In an embodiment of the present disclosure the request includes an indication of one or more of for the ranging service: the target UE, the reference UE, a location Quality of Service, a number of events addressing distance and/or direction measurements between the reference and target UE, a threshold distance for an event, a threshold direction for an event, a time to trigger for an event, a direction orientation for an event, a threshold matching direction for an event, a measurement frequency for an event, a preferred accuracy for an event, and a privacy preservation criteria for an event.

In an embodiment of the present disclosure reporting the result of the ranging includes transmitting, to the requesting entity, an indication that a reporting threshold has been reached for at least one of: a range between the target UE and the reference UE, a range accuracy between the target UE and the reference UE, a ranging latency between the target UE and the reference UE, a direction between the target UE and the reference UE, a direction accuracy between the target UE and the reference UE, and a direction latency between the target UE and the reference UE.

In an embodiment of the present disclosure the request is communicated via the GMLC and the GMLC utilises a service operation of an Access and Mobility Management Function (AMF) to request the ranging service.

FIG. 8 is a flowchart illustrating a method of a requesting entity for requesting a ranging service between a reference user equipment (UE) and a target UE in a wireless communications system, according to an embodiment of the disclosure.

In operation 810, the requesting entity transmits, to the reference UE, a request for a ranging service with the target UE. The requesting entity may be one of a ranging application server or a ranging application function. The request may be directly or indirectly communicated to the reference UE via one or more of the GMLC or the LMF of the 5G mobile communications system to enable the ranging services to be initiated, controlled or configured by an increased range of external entities, such as the Ranging Application Server. The requesting entity may be a ranging application server and the request may be communicated to the GMLC directly or via a Network Exposure Function (NEF). The ranging/sidelink positioning service request may be transmitted via the NEF. The request includes one or more parameters for configuration of the ranging. The LMF checks the ProSe capabilities registered for the UEs with the AMF, the ProSe AS or PCF configures the UE to provide location reporting as needed, and a connection is established for a PC5 communication session. The LMF sends a ranging/sidelink positioning request to the reference UE.

In operation 820, requesting entity receives, from the reference UE, a report of a result of the ranging. The report may be received via one or more of the GMLM and LMF.

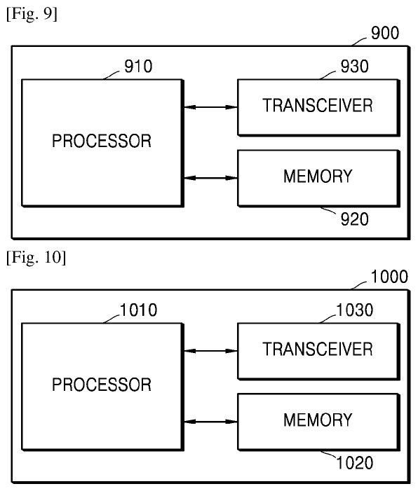

FIG. 9 is a block diagram of a UE, according to an embodiment of the disclosure. The UE may be one of the reference UE and the target UE.

Referring to FIG. 9, the UE 900 may include a processor 910, a transceiver 930, and memory 920. The memory 920 stores instructions that, when executed by the processor 910, cause the processor to perform the transmission method as described above with reference to FIGS. 1-8. However, components of the UE are not limited to the examples set forth above. For example, the UE may include more components or less components than the components set forth above. In addition, the processor 910, the transceiver 930, and the memory 920 may be implemented in the form of one chip.

The processor 910 may control a series of processes in which the UE may be operated according to the above-described embodiments of the disclosure. The transceiver 930 may transmit a signal to and receive a signal from a gNB. The signal set forth above may include control information and data. For this purpose, the transceiver 930 may include a radio frequency (RF) transmitter up-converting and amplifying a frequency of a transmitted signal, an RF receiver performing low-noise amplification and frequency down-conversion on a received signal, and the like. In addition, the transceiver 930 may receive a signal through a radio channel and output the signal to the processor 910, and may transmit, through the radio channel, a signal that is output from the processor 910.

The memory 920 may store at least one of information transmitted and received by the transceiver 930 or information generated by the processor 910. In addition, the memory 920 may store control information or data included in an acquired signal. The memory 920 may include a storage medium such as read-only memory (ROM), random access memory (RAM), a hard disk, compact disc ROM (CD-ROM), and a digital versatile disc (DVD), or a combination of storage media. Further, the memory 920 may include a plurality of memories.

FIG. 10 is a block diagram of a core network object in a wireless communication system, according to an embodiment of the disclosure.

“Unit”, “module”, “block”, etc., used herein each represent a unit for handling at least one function or operation, and may be implemented in hardware, software, or a combination thereof. In an embodiment of the disclosure, the core network object may include AMF, LMF, ProSe AS, PCF, GMLC, UDM, NEF, ranging Application Server, without being limited thereto.

Referring to FIG. 10, the core network object may include a transceiver 1010, a memory 1020, and a processor 1030. The transceiver 1010 may provide an interface for communicating with other devices in the network. Specifically, the transceiver 1010 may convert a bitstream to be transmitted to another device from the core network object into a physical signal and convert a physical signal received from the other device into a bitstream. That is, the transceiver 1010 may transmit or receive a signal. Hence, the transceiver 1010 may also be referred to as a modem, a transmitter, a receiver, a communication unit, or a communication module. In this case, the transceiver 1010 may allow the core network object to communicate with other devices or systems through backhaul connection (e.g., wired backhaul or wireless backhaul) or other connection methods, or over a network.

The memory 1020 may store a basic program for operation of the core network object, an application program, and data such as settings information. The memory 1020 may include a volatile memory, a non-volatile memory, or a combination of the volatile memory and the non-volatile memory. The memory 1020 may also provide the stored data at the request of the processor 1030.

The processor 1030 may control general operation of the core network object. For example, the processor 1030 may transmit or receive a signal through the transceiver 1010. The processor 1030 may record data to the memory 1020 or read out data from the memory 1020. For this, there may be at least one processor 1030. The processor 1030 may control the core network object to operate according to an embodiment of the disclosure as will be described below. For example, the processor 1030 may control components of the core network object to perform the method of providing a service requested by the UE according to the disclosure.

The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

Any of the described network entities may be implemented as a network element on a dedicated hardware, as a software instance running on a dedicated hardware, and/or as a virtualised function instantiated on an appropriate platform, e.g. on a cloud infrastructure.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in the accompanying claims.

1. A method performed by a first user equipment (UE) in a wireless communications system, the method comprising:
receiving from a location management function (LMF) entity, a request for ranging;
performing the ranging; and
transmitting to the LMF entity, a result of the ranging,
wherein the ranging is determining of at least one of a distance or a direct from the first UE to a second UE.

2. The method of claim 1, wherein the request is originated from an application function (AF) entity.

3. The method of claim 2, wherein the request is transmitted from the AF entity to a Gateway Mobile Location Centre (GMLC) entity directly or via a Network Exposure Function (NEF) entity.

4. The method of claim 3, wherein the GMLC entity requests location information to an Access and Mobility Management Function (AMF) entity.

5. The method of claim 1, wherein the method further comprises transmitting at least one of a ranging capability of the second UE or a ranging capability of the first UE to an Access and Mobility Management Function (AMF) entity.

6. The method of claim 5, wherein the ranging capability includes one or more of a proximity-based services (ProSe) capability and a Location Privacy Indication (LPI).

7. The method of claim 1, wherein the ranging comprises sidelink positioning.

8. The method of claim 1, wherein the ranging comprises at least one of distance measurement or direction measurement.

9. The method of claim 1, wherein the result is transmitted from the LMF entity to an application function (AF) entity via at least one of an Access and Mobility Management (AMF) entity or an Gateway Mobile Location Centre (GMLM) entity.

10. The method of claim 1, wherein the request includes one or more parameters for configuration of the ranging, and the method further comprises configuring the first UE based on the one or more parameters.

11. The method of claim 10, wherein the
configuring of the first UE is performed by a ProSe Application Server (ProSe AS) or a Policy Control Function (PCF) entity.

12. The method of claim 1, wherein
the request includes at least one of:
the second UE,
the first UE,
information for Quality of Service (Qos),
a distance threshold for an event,
information for a time to trigger for an event, or
information for a measurement frequency for an event.

13. The method of claim 1, wherein the transmitting of the result of the ranging comprises transmitting, to the LMF entity, an indication that a reporting threshold has been reached for a range between the second UE and the first UE.

14. A first user equipment (UE) in a wireless communications system, the first UE comprising:
a transceiver; and
at least one processor configured to:
receive from a location management function (LMF) entity,
a request for ranging;
perform the ranging; and
transmit to the LMF entity, a result of the ranging,
wherein the ranging is determining of at least one of a distance or a direct from the first UE to a second UE.

15. A method performed by a location management function (LMF) entity in a wireless communications system, the method comprising:
receiving, from an application function (AF) entity, a request for ranging;
transmitting, to a first UE, the request for the ranging, wherein the first UE performs the ranging; and
receiving, from the first UE, a result of the ranging,
wherein the ranging is determining of at least one of a distance or a direct from the first UE to a second UE.
